(19) United States
(12) Patent Application Publication
(10) Pub. No.: US 2010/0055269 A1
(43) Pub. Date: Mar. 4, 2010

(54) METHOD FOR PRODUCTION OF COCONUT WATER BEVERAGE AND BLENDED JUICE BEVERAGES WITH COCONUT WATER

(75) Inventors: Kellie Haynes, Tampa, FL (US); Rachel Bundang, Palmetto, FL (US); Osvaldo Chu, Sarasota, FL (US); Christian Eichinger, St. Petersburg, FL (US); D. Scott Lineback, Bradenton, FL (US); Albert D. Bolles, Sarasota, FL (US)

Correspondence Address: BANNER & WITCOFF, LTD.;and ATTORNEYS FOR CLIENT NO. 006943, 10 SOUTH WACKER DR., SUITE 3000, CHICAGO, IL, 60606, US

(73) Assignee: Tropicana Products, Inc., Bradenton, FL (US)

(21) Appl. No.: 12/550,538

(22) Filed: Aug. 31, 2009

Related U.S. Application Data
(63) Continuation of application No. 10/201,395, filed on Jul. 23, 2002, now abandoned.

(51) Int. Cl. A23L 2/38; A23L 2/42; A23L 2/52; A23L 2/68

(52) U.S. Cl. 426/330.5; 426/599

(57) ABSTRACT

A method for producing a coconut water beverage having a pH below 4.5 by adding a food grade acid to coconut water. The method coverts coconut water from a low-acid food to a high-acid food which allows the coconut water to be subjected to less severe commercial sterilization processing and preserves the natural taste and aroma of the coconut water. The present invention is also directed to a blended beverage comprising coconut water and fruit juice and having natural isotonic properties.

### FIELD OF THE INVENTION

The present invention is directed to a method of production of coconut water as an acceptable and fulfilling beverage and to blended juice beverages having natural isotonic properties by adding coconut water.

### BACKGROUND OF THE INVENTION

Coconut water is a liquid endosperm filling the central cavity of coconuts. Coconut water should not be confused with coconut oil or coconut milk. Each of these are associated with the meat (solid endosperm) of the coconut. For example, coconut milk is produced by processing or squeezing coconut meat. Coconut oil is, for example, formed by pressing or squeezing coconut meat to produce coconut milk and then letting the milk sit to allow the water and solids to separate from the oil. Other, more elaborate, separation techniques are also available for such purposes. In contrast, coconut water is the liquid from the center of the coconut and is not associated with the meat of the coconut.

Coconut water is widely known to both local inhabitants and visitors of tropical areas to be a refreshing drink. Coconut water also is a naturally occurring isotonic fluid that provides an excellent source of hydration because of the many natural electrolytes in the coconut water.

A coconut water beverage would be considered a thermally processed food. The pH classification for such a food is extremely important in the prevention of Clostridium botulinum from growing and producing a deadly botulism toxin. Such a toxin does not grow in a food with a pH below 4.6. As a result, foods with a pH below 4.5 are classified as high-acid foods while foods with a pH above 4.5 are classified as low-acid foods.

In order to ensure adequate destruction of microorganisms and to prevent Clostridium botulinum from growing and producing botulism toxins, the U.S. Food and Drug Administration established a minimal thermal process for commercialization of thermally processed food. For low-acid foods, the FDA requires temperatures of 115-125° C. while temperatures below 100° C. are acceptable for high-acid foods.

Unfortunately, the natural pH of coconut water falls in the range of 4.8 to 5.2. As a result, it is categorized as a low-acid food product. As explained above, for commercial production, such a low-acid food product requires a retort heat process at a temperature of approximately 15-125° C. to render it commercially sterile. Such a process, however, not only renders the product commercially sterile, but it also significantly degrades the sensory attributes, such as taste and aroma, of the coconut water. For example, the low-acid heat process produces a foul, overcooked aroma and taste in the coconut water.

Therefore, it is an object of the present invention to lower the pH of coconut water to a level below 4.5 so that the coconut water will be classified as a high-acid food product, as high-acid food products do not endure the severe heat treatment applied to low-acid food products. Accordingly, an object of the present invention is to develop a method for producing a coconut water beverage that has a pH below 4.5 so as to maintain the natural pleasing aroma and taste of the coconut water. It is believed that the process of the invention for lowering the pH to a level below 4.5 has not been previously applied to coconut water.

It is a further object of the present invention to produce a blended juice beverage having natural isotonic properties by using coconut water.

### SUMMARY OF THE INVENTION

The present invention is directed to a method or process for producing coconut water or a coconut water beverage having a pH below 4.5. The method of the present invention comprises the step of adding a pH lowering component to coconut water until the pH of the resulting composition is below 4.5. In a preferred embodiment, a food grade acid, preferably phosphoric acid, is added to lower the pH.

In a further embodiment, the coconut water and acid mixture, having a pH below 4.5, are subjected to a pasteurization process to achieve commercial sterilization of the resulting coconut water or coconut water beverage. The pasteurization process is performed at time and temperature conditions which are sufficient for high-acid products and which are lower or less harsh than those required for low-acid products.

Another embodiment of the present invention is directed to blended juice beverages having natural isotonic properties. Preferably, fruit juice is blended with the coconut water in the beverage. The coconut water provides isotonic properties to the beverage which would not be present if ordinary water was added to the beverage. Preferably, the coconut water has a food grade acid, such as for example, phosphoric acid, added thereto to lower the pH of the coconut water below 4.5. Multiple fruit juice sources can be included in the beverage. Other additives can also be added to the beverage.

In a further embodiment, other additives to be added to the coconut water beverage or the blended juice beverages include, for example, flavor, color, fruit acid, sweetener, and so-called “key” flavors or juices.

### DETAILED DESCRIPTION OF THE PRESENTLY PREFERRED EMBODIMENTS

The present invention is designed to produce coconut water or a coconut water beverage that can be packaged, distributed and sold commercially, yet still has the refreshing taste and natural electrolytes of fresh coconut water. The present invention is directed to the realization that if the pH of the coconut water can be lowered to a level below 4.5, the lowered pH coconut water can undergo high-acid food grade pasteurization to meet wholesomeness and microbial-control requirements for commercially distributed foods and beverages. Such pasteurization techniques for high-acid foods are well known in the food industry and typically utilize temperatures below 100° C. for a short period of time. These pasteurization techniques will not destroy the natural pleasing taste and aroma of the coconut water, as do higher times and/or temperatures which typically are needed for low-acid foods and beverages.

In the method of the present invention, the pH of the coconut water is lowered by directly adding a component for lowering the pH of the coconut water. Typically, the pH lowering component will be an acid, such as a food grade acid, which is directly added to the coconut water. The amount and type of acid can be varied depending on the desired tartness profile and target pH.

While other acids can be used, phosphoric acid is preferred because of its cost efficiency and the discovered desirable sensory properties of the coconut water and coconut water beverage made with phosphoric acid. Other acids can provide an overly sour or tart taste to the coconut water and coconut water beverage.

In one embodiment of the method of the present invention, approximately 0.1 to less than 1 weight % of food grade acid, such as for example phosphoric acid, is added to the coconut water to produce coconut water having a pH below 4.5. The resulting coconut water maintains its fresh taste and natural isotonic properties and can be sold as coconut water or added to other beverages as discussed infra.

In another embodiment, flavoring and/or color can be added to the coconut water to produce a flavored and/or colored coconut water beverage. Example 1 provides an illustrative example of a formulation used in the method of the present invention to produce a flavored coconut water beverage.

### EXAMPLE 1

### Flavored Coconut Water Beverage

| | |
|---|---|
| Coconut Water | >98% |
| Phosphoric Acid | <1% |
| Flavor | 0-1% |
| Color | 0-0.5% |

The percentage of flavor used can be varied according to desired taste while the percentage of color added can also be varied to achieve desired color.

In another embodiment, other additives, such as sweetener, can also be added to the coconut water beverage to produce flavored, sweetened beverages. Fruit acid can also be added to the beverage. Examples of fruit acids include citric acid, malic acid, tartaric acid and other similar acids. Preferably, preservatives are not added to the beverage. Such preservatives can be added, however, if necessary. Example 2 illustrates the processing formulation of an example of a flavored, sweetened coconut water beverage made in accordance with the present invention.

### EXAMPLE 2

### Flavored, Sweetened Coconut Water Beverage

| | |
|---|---|
| Coconut Water | 93.6-96.55% |
| Phosphoric Acid | 0.15-0.2% |
| Fruit Acid | 0.2-0.3% |
| Sweetener | 3.0-5.0% |
| Flavor | 0.1-0.6% |
| Color | 0-0.3% |

The percentage of the various components can be varied according to desired taste and color. For example, the more fruit acid added, the tarter the taste of the beverage.

Another embodiment of the present invention is directed to blended juice beverages having natural isotonic properties. Such blended juice beverages include coconut water, instead of regular water, to provide the natural isotonic properties to the beverage. Regular water refers to conventionally provided water sources, which do not exhibit substantial isotonic properties such as tap water, city water, softened water, distilled water, and other water sources. Such blends add fruit flavors to the flavor of the coconut water. They can be blended flavor juices within which some or all of the water component is replaced with the coconut water, as described herein. In such embodiments, it is not necessary to add any additional non-natural isotonic materials to the beverage. The fruit juice can be, for example, in either a concentrate form or a single strength form. Preferably the coconut water has a pH of below 4.5 and is produced using the above method of the present invention. Example 3 illustrates the processing formula of an example of a blended fruit juice made with coconut water in accordance with the present invention.

### EXAMPLE 3

### Flavored Juice Blends With Coconut Water

| | |
|---|---|
| Coconut Water | 90.6-96.55% |
| Phosphoric Acid | 0.15-0.2% |
| Fruit Acid | 0.2-0.3% |
| Fruit Juice | 3.0-8.0% |
| Flavor | 0.1-0.6% |
| Color | 0-0.3% |

The amount of fruit juice used can be varied according to the target level for that beverage. The percentage of flavor and other additives can also be varied according to desired taste and color for the beverage.

The examples provided herein are being submitted to illustrate various beverages that can be produced using the present invention. The examples are not intended to limit the invention. Any of these coconut water beverages can also be carbonated.

It will be understood that the embodiments and examples of the present invention, which have been described, are illustrative of some of the applications of the principles of the present invention. Numerous modifications may be made by those skilled in the art without departing from the true spirit and scope of the invention.

1. A method for producing a coconut water beverage comprising:
combining coconut water with a food grade acid in an amount sufficient to lower the pH of the coconut water to a level below 4.5.

2. The method of claim 1 wherein said food grade acid is phosphoric acid.

3. The method of claim 2 wherein said phosphoric acid is added in an amount of less than 1 weight %, based upon the total weight of said coconut water beverage.

4. The method of claim 2 further comprising adding flavor and color to said coconut water beverage.

5. The method of claim 4 further comprising adding fruit acid and sweetener to said coconut water beverage.

6. The method of claim 4 further comprising adding fruit acid and fruit juice to said coconut water beverage.

7. The method of claim 3 further comprising adding 1 weight % or less of flavor and 0.5 weight percent or less of color to said coconut water beverage.

8. The method of claim 5 further comprising adding between approximately 0.2 to 0.3 weight % of fruit acid and between approximately 3 to 5 weight % of sweetener.

9. The method of claim 6 further comprising adding between approximately 0.2 to 0.3 weight % of fruit acid and between approximately 3 to 8 weight % of fruit juice.

10. A method for producing a coconut water beverage comprising:
combining coconut water with a food grade acid in an amount sufficient to lower the pH of the coconut water to a level below 4.5 so as to produce a high-acid product; and
subjecting the high-acid product to a pasteurization process at reduced time-temperature conditions sufficient to achieve commercial sterilization for high-acid products, said time-temperature conditions being lower than corresponding conditions for commercial sterilization for a low-acid product, to produce the coconut water beverage.

11. The method of claim 10 wherein said food grade acid is phosphoric acid.

12. The method of claim 11 wherein said phosphoric acid is added in an amount of less than 1 weight %, based upon the total weight of said coconut water beverage.

13. The method of claim 1 further comprising adding flavor to said coconut water beverage.

14. The method of claim 11 further comprising adding color to said coconut water beverage.

15. The method of claim 13 further comprising adding color to said coconut water beverage.

16. The method of claim 13 further comprising adding fruit acid to said coconut water beverage.

17. The method of claim 15 further comprising adding fruit acid to said coconut water beverage.

18. The method of claim 13 further comprising adding sweetener to said coconut water beverage.

19. The method of claim 17 further comprising adding sweetener to said coconut water beverage.

20. The method of claim 13 further comprising adding fruit juice to said coconut water beverage.

21. The method of claim 15 further comprising adding fruit juice and fruit acid to said coconut water beverage.

22. The method of claim 12 further comprising adding 1 weight % or less of flavor and 0.5 weight percent or less of color to said coconut water beverage.

23. The method of claim 10 further comprising adding between approximately 0.2 to 0.3 weight % to of fruit acid and between approximately 3 to 5 weight % of sweetener.

24. The method of claim 10 further comprising adding between approximately 0.2 to 0.3 weight % of fruit acid and between approximately 3 to 8 weight % of fruit juice.

25. A blended juice beverage comprising:
a combination of at least one fruit juice together with a water component, wherein said water component is coconut water and wherein said blended beverage has natural isotonic properties imported to the beverage by said coconut water.

26. The beverage of claim 25 wherein said combination comprises between 80 to 97 weight percent of coconut water, and between approximately 3 to 8 weight percent of fruit juice,

27. The beverage of claim 25 wherein phosphoric acid is added to said beverage during preparation of said beverage.

28. The beverage of claim 27 wherein the phosphoric acid added is less than 1 weight % of the total weight of said coconut water beverage.

29. The beverage of claim 25 wherein a food grade acid is used during processing to lower the pH of the coconut water below 4.5.

30. The beverage of claim 26 further comprising 1.0 weight % or less of flavor and 0.5 weight percent or less of color in said blended juice beverage.

31. The beverage of claim 30 further comprising between approximately 0.2 to 0.3 weight % of fruit acid and between approximately 3 to 5 weight % of sweetener in said blended juice beverage.

32. The beverage of claim 26 further comprising between approximately 0.2 to 0.3 weight % of fruit acid in said blended juice beverage.

33. The beverage of claim 25 wherein said coconut water is the liquid endosperm filling the central cavity of a coconut.

34. A coconut water beverage comprising coconut water and having a pH below 4.5.

35. The coconut water beverage of claim 34 further comprising fruit juice.

36. The beverage of claim 34 wherein phosphoric acid is added to said beverage during preparation of said beverage.

37. The beverage of claim 36 wherein the phosphoric acid added is less than 1 weight % of the total weight of said coconut water beverage.

38. The beverage of claim 34 wherein a food grade acid is used during processing to lower the pH of the coconut water below 4.5.

39. The beverage of claim 34 further comprising 1.0 weight % or less of flavor and 0.5 weight percent or less of color in said coconut water beverage.

40. The beverage of claim 34 further comprising between approximately 0.2 to 0.3 weight % of fruit acid and between approximately 3 to 5 weight % of sweetener in said coconut water beverage.

41. The beverage of claim 34 further comprising between approximately 0.2 to 0.3 weight % of fruit acid in said coconut water beverage.
